(19) United States
(12) Patent Application Publication
(10) Pub. No.: US 2007/0059020 A1
(43) Pub. Date: Mar. 15, 2007

(54) Electrophotographic apparatus capable of effectively reducing volatile organic compound

(76) Inventor: Takahiro Yoshikawa, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/521,506

(22) Filed: Sep. 15, 2006

(30) Foreign Application Priority Data
Sep. 15, 2005 (JP) 2005-267790

(51) Int. Cl. G03G 15/00; G03G 21/00

(52) U.S. Cl. 399/91

(57) ABSTRACT

An electrophotographic apparatus for forming a toner image on a recording medium including an image fixing apparatus and a member for reducing a harmful volatile organic compound (VOC) generated by heat of the image fixing apparatus. The image fixing apparatus is configured to fix the toner image onto the recording medium by heat and pressure. Additionally, a member including an activated carbon is provided at a predetermined position adjacent the image fixing apparatus and configured to contact heated air generated by the image fixing apparatus.

### BACKGROUND OF THE INVENTION

1. Field of the Invention

The present invention generally relates to an electrophotographic apparatus, such as a printer, a copying machine, and a facsimile machine, and more particularly to an electrophotographic apparatus capable of reducing volatile organic compound generated with heat of an image fixing apparatus.

2. Discussion of the Background

Image forming apparatuses, such as printers, copying machines, and facsimile machines, which use an electrophotographic method are generally regulated by law with respect to the generation of bad odors and the content of toxic substances generated. The amount of generated volatile organic compound (VOC) has been standardized by law in recent years. The amount of generated VOC is easy to change based on the amount of heat used in the electrophotographic apparatus. The heat generated by an image fixing apparatus using a heat roller or a heat belt largely affects the amount of generated VOC. The greater the amount of heat generated by the apparatus, the greater the total amount of VOC (TVOC) generated. The main source of the VOC is adhesives and silicone rubber in the image fixing apparatus. The VOC is generated from the adhesives and silicone rubber at fixing temperature. Such VOC is needed to be reduced.

To reduce the VOC, in one example, a filter containing activated carbon is provided at an exhaust slot like the method of reducing ozone. Specifically, two or more tubular exhaust passageways are provided with a filter containing activated carbon behind an exhaust fan.

In another example, an electrophotographic apparatus has an air vacuum, a dust filter, a photocatalyst filter, and an ultraviolet-rays lamp to reduce the VOC physically and chemically.

### SUMMARY OF THE INVENTION

A novel electrophotographic apparatus effectively reduces a harmful volatile organic compound (VOC) generated by heat of an image fixing apparatus. In one example, a novel electrophotographic apparatus for forming a toner image on a recording medium includes an image fixing apparatus to fix the toner image onto the recording medium by heat and pressure and a member including an activated carbon provided above the image fixing apparatus for reducing the generated VOC.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration illustrating an exemplary configuration of an electrophotographic apparatus according to an exemplary embodiment of the present invention;

FIG. 2 is an illustration of an image fixing apparatus of the electrophotographic apparatus of FIG. 1;

FIG. 3 is an illustration of a paper ejection section of the image fixing apparatus of FIG. 2;

FIG. 4 is an illustration of an exemplary configuration of a cover in the electrophotographic apparatus of FIG. 1;

FIG. 5 is an illustration of another exemplary configuration of a cover in the electrophotographic apparatus of FIG. 1; and

FIG. 6 is an illustration of another exemplary configuration of a cover in the electrophotographic apparatus of FIG. 1.

### DETAILED DESCRIPTION OF PREFERRED EMBODIMENTS

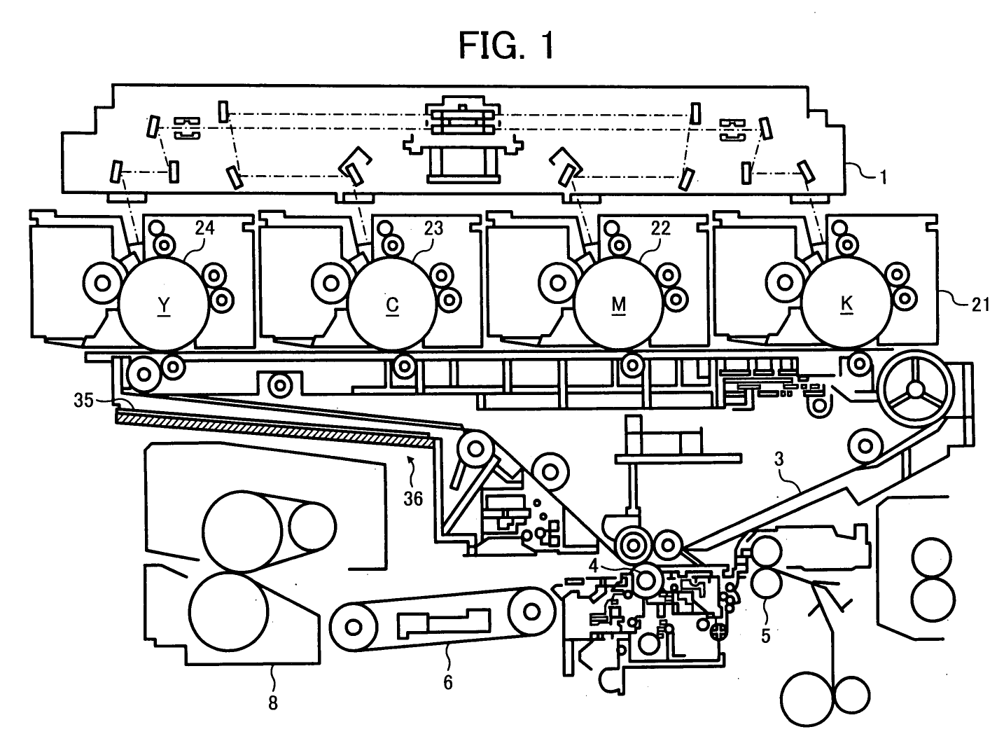

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an electrophotographic apparatus 1 according to an exemplary embodiment of the present invention is explained.

FIG. 1 is an illustration illustrating an exemplary configuration of an electrophotographic apparatus according to an exemplary embodiment of the present invention. An exposing unit 1 makes a toner image on photo conductors 21, 22, 23, and 24 for each color based on image data from a scanner or a personal computer. The toner image is transferred onto a middle transfer belt 3 to make a mixed color image. The toner image is transferred using a second transfer 4 from the middle transfer belt 3 onto a paper sheet conveyed by a resist roller 5. The paper sheet with transferred toner image is conveyed into an image fixing apparatus 8 by a conveyor belt 6 and the toner image is fixed on the paper sheet with heat and pressure in the image fixing apparatus 8.

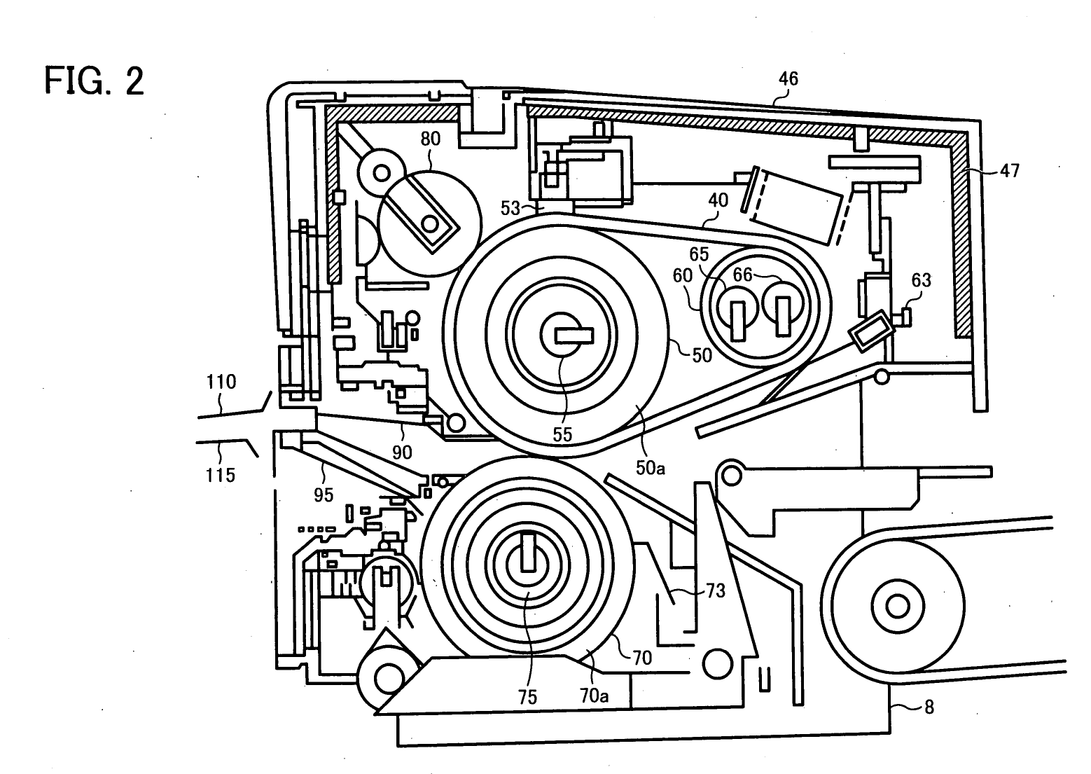

FIG. 2 is an illustration of an image fixing apparatus 8 of the electrophotographic apparatus of FIG. 1. The image fixing apparatus 8 includes a fixing roller 50 having a heater 55 as a heat source. Fluoro-resin is provided on the surface of the fixing roller 50 made of silicone rubber 50a. A pressing roller 70 presses the fixing roller 50 and rotates with the fixing roller 50. The temperature of the surface of the fixing roller 50 is detected with a temperature sensor 53 for controlling fixing temperature. The toner image is fixed on the paper sheet with heat and pressure at the fixing temperature.

The image fixing apparatus 8 is a belt type image fixing apparatus. The heating roller 60 made of metal also includes heaters 65 and 66. A fixing belt 40 made of metal base such as nickel, stainless steel, etc. or made of resin base such as polyimide, polyamide-imide, etc. is tensed between the fixing roller 50 and the heating roller 60. Fluoro-resin is provided on the silicone rubber on the base of the fixing belt 40. The fixing belt 40 is driven to rotate by the fixing roller 50.

The pressing roller 70 also includes a heater 75 as a heat source. Fluoro-resin is provided on the surface of the pressing roller 70 made of silicone rubber 70a. The heaters 55, 65, 66, and 75 are ON-OFF controlled based on the detected temperature using the temperature sensors 53, 63, and 73. Two or more temperature sensors 53 detect the temperatures of the center region and the end region in the main scanning direction of the fixing belt 40, respectively.

A pressing nip region is formed between the fixing belt 40 and the pressing roller 70 with distortion of the silicone rubbers 50a and 70a. The toner image on the paper sheet is fixed on the paper sheet by receiving heat and pressure in the nip region. A waste toner on the fixing belt 40 is cleaned by a cleaning roller 80.

In FIG. 1, a member 36 containing activated carbon is formed on the fixing apparatus 8 side of a cover 35 with which the heat of fixing is prevented from reaching the middle transfer belt 3. The VOC rises with the heated air from the image fixing apparatus 8. The VOC is reduced by adsorption of the activated carbon in the member 36 without disturbing the air flow of the heat. This simple construction may effectively reduce the VOC output.

In FIG. 2, the fixing apparatus 8 has a cover 46 for reducing the effect of heat to the other units. A member 47 containing activated carbon is provided on the inside surface of the cover 46. The VOC rises with air heated by the rollers 50, 60, and 70 in the image fixing apparatus 8, and the VOC collects inside the cover 46. The VOC is reduced by adsorption of the activated carbon in the member 47 without raising the temperature inside of the electrophotographic apparatus due to disturbing the air flow of the heat. This simple construction may effectively reduce the VOC output.

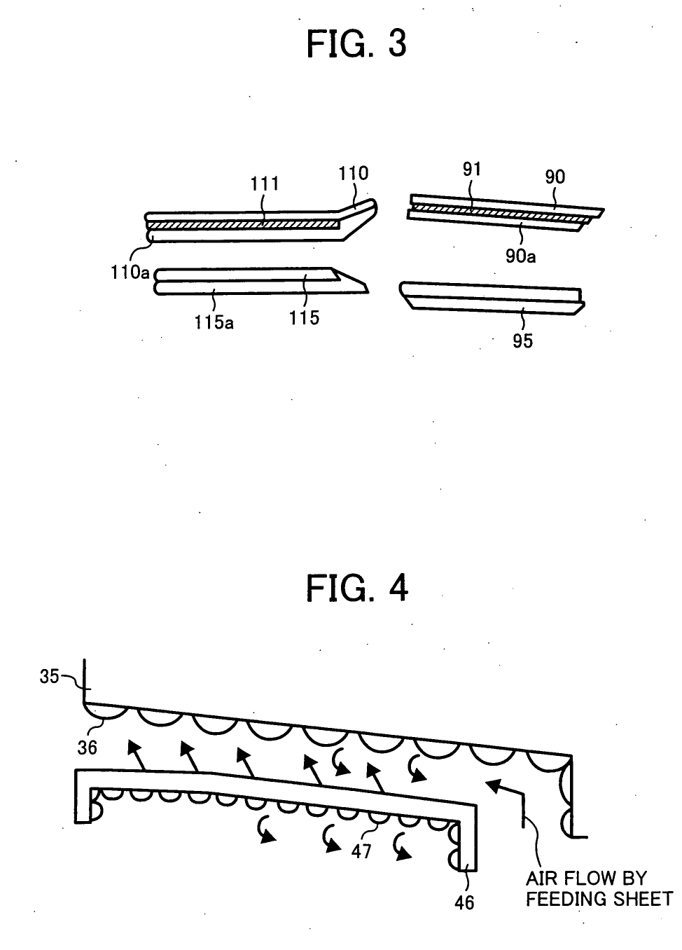

FIG. 3 is an illustration of a paper ejection section of the image fixing apparatus of FIG. 2. The paper ejection section of the image fixing apparatus 8 has paper guides 90, 95, 110, and 115. Ribs 90a are provided on the upper paper guide 90. A member 91 containing activated carbon is also provided between the ribs 90a on the upper paper guide 90 so that the member 91 is shorter than the ribs 90a. Ribs 110a are provided on the upper paper guide 110. A member 111 containing activated carbon is also provided between the ribs 110a on the upper paper guide 110 so that the member 111 is shorter than the ribs 110a. The VOC is discharged along with the upper paper guides 90 and 110 with the air flow caused by the heat of fixing and the conveyance of the paper. The ribs 90a and 110a effectively lead the VOC, so the members 91 and 111 containing activated carbon between the ribs 90a and 110a effectively absorb the VOC without increasing conveyance load of the paper and air resistance. This simple construction may effectively reduce the VOC output.

FIG. 4 is an illustration of another exemplary configuration of a cover in the image fixing apparatus of FIG. 1. The members 36 and 47 are formed in the shape of a waveform sheet. The members 36 and 47 include the activated carbon and the members 36 and 47 are provided so that the waveform is formed one by one in the sub-scanning direction. Air flow generated toward the sub-scanning direction by the conveyance of the sheet and by heat of the image fixing apparatus 8 may be held in the waveform members 36 and 47. Therefore, the holding time of the VOC along with the members 36 and 47 may be longer than that of the above-mentioned members 36 and 47 in FIG. 3 having flat surfaces. This effectively reduces the VOC by providing a longer time of adsorption into the activated carbon.

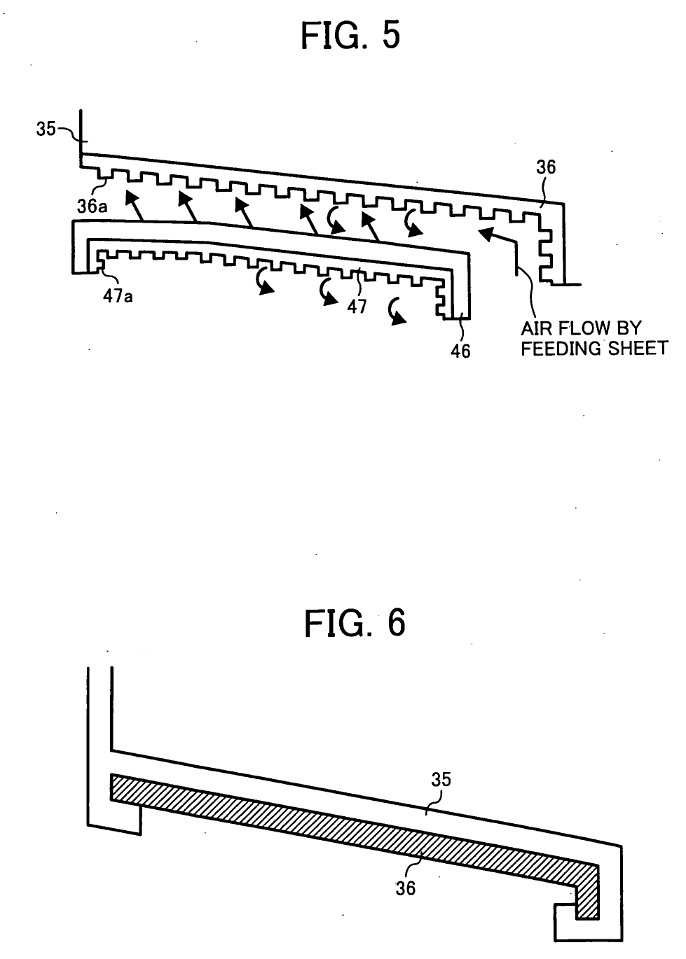

FIG. 5 is an illustration of another exemplary configuration of a cover in the image fixing apparatus of FIG. 1. The members 36 and 47 are formed in the shape of a sheet having ribs 36a and 47a on it. The members 36 and 47 include the activated carbon and the members 36 and 47 are provided so that the ribs 36a and 47a are formed one by one in the sub-scanning direction. Air flow generated toward the sub-scanning direction by the conveyance of the sheet and by heat of the image fixing apparatus 8 may be held between the ribs 36a and 47a. Therefore, the holding time of the VOC between the ribs 36a and 47a along with the members 36 and 47 may be longer than that of above-mentioned members 36 and 47 in FIG. 3 having flat surface. This effectively reduces the VOC by providing a longer time of adsorption into the activated carbon.

FIG. 6 is an illustration of another exemplary configuration of a cover in the image fixing apparatus of FIG. 1. The cover 35 has a hook at the end position to retain the member 36 including the activated carbon. The same hook configuration can also be used for the cover 46 to retain member 47. Therefore, if the adsorption force is reduced with age, it is easy to replace the activated carbon members 36 and 47 with new ones. This effectively reduces the VOC with age.

Numerous additional modifications and variations are possible in light of the above teachings. It is therefore to be understood that within the scope of the appended claims, the disclosure of this patent specification may be practiced otherwise than as specifically described herein.

This patent specification is based on Japanese Patent Application No. JPAP2005-267790 filed on Sep. 15, 2005 in the Japan Patent Office, the entire contents of which is incorporated by reference herein.

What is claimed:

1. An electrophotographic apparatus for forming a toner image on a recording medium, said electrophotographic apparatus comprising:
an image fixing apparatus configured to fix the toner image onto the recording medium by heat and pressure; and
a member including an activated carbon provided at a predetermined position adjacent said image fixing apparatus and configured to contact heated air generated by said image fixing apparatus.

2. The electrophotographic apparatus of claim 1, further comprising:
a bracket provided above the image fixing apparatus,
wherein said member is mounted to said bracket.

3. The electrophotographic apparatus of claim 1, further comprising:
a cover configured to reduce heat transfer from said image fixing apparatus to an outside of said image fixing apparatus;
wherein said member is mounted to an inside surface of said cover.

4. The electrophotographic apparatus of claim 1, further comprising:
a guide configured to guide the recording medium ejected from said image fixing apparatus, said guide including a plurality of ribs,
wherein said member is provided between said ribs of said guide.

5. The electrophotographic apparatus of claim 1, wherein said member has a waveform surface in which a longitudinal direction of waves in the waveform extends in a direction perpendicular to a conveyance direction of the recording medium.

6. The electrophotographic apparatus of claim 1, wherein said member has a surface having ribs in which a longitudinal direction of said ribs extends in a direction perpendicular to a conveyance direction of the recording medium.

7. The electrophotographic apparatus of claim 1, wherein said member is detachably provided in said electrophotographic apparatus.

8. An electrophotographic apparatus for forming a toner image on a recording medium, said electrophotographic apparatus comprising:
an image fixing apparatus configured to fix the toner image onto the recording medium by heat and pressure; and
means for reducing a volatile organic compound generated by heat of said image fixing apparatus,

9. The electrophotographic apparatus of claim 8, wherein said means for reducing includes an activated carbon provided on a bracket above said image fixing apparatus.

10. The electrophotographic apparatus of claim 8, wherein said means for reducing includes an activated carbon provided on an inside surface of a cover over said image fixing apparatus.

11. The electrophotographic apparatus of claim 8, wherein said means for reducing includes an activated carbon provided on a guide configured to guide the recording medium ejected from said image fixing apparatus, said guide including a plurality of ribs, and wherein said activated carbon is provided between said ribs of said guide.

12. The electrophotographic apparatus of claim 8, wherein said means for reducing includes an activated carbon member having a waveform surface in which a longitudinal direction of waves in the waveform extends in a direction perpendicular to a conveyance direction of the recording medium.

13. The electrophotographic apparatus of claim 8, wherein said means for reducing includes an activated carbon member having a surface with ribs in which a longitudinal direction of said ribs extends in a direction perpendicular to a conveyance direction of the recording medium.

14. The electrophotographic apparatus of claim 8, wherein said means for reducing includes an activated carbon member that is detachably provided in said electrophotographic apparatus.
